(19) United States
(12) Patent Application Publication
(10) Pub. No.: US 2025/0033236 A1
(43) Pub. Date: Jan. 30, 2025

(54) Chain Saw

(71) Applicant: Ningbo Junfeng Tools Co., Ltd., Ningbo City (CN)

(72) Inventor: Tao Chen, Nanjing City (CN)

(21) Appl. No.: 18/505,577

(22) Filed: Nov. 9, 2023

(30) Foreign Application Priority Data
Jul. 28, 2023 (CN) 202322017198.1

(51) Int. Cl. B27B 17/12

(52) U.S. Cl. CPC B27B 17/12

(57) ABSTRACT

The disclosure provides a chain saw, which includes: a case; a working component extending out of the case, the working component having a cutting element and a guide plate supporting the cutting element; a power drive device, including a motor positioned in the case, the motor drives the cutting element to move around the guide plate; a switch trigger, arranged on the case and starts the motor; and a lubricating component, arranged in the case and provides oil for the cutting element. The chain saw includes a lock knob capable of locking and releasing the switch trigger. The lubricating component includes an oil bubble arranged in the case and is close to the lock knob. The lock knob compresses the oil bubble to perform an oil discharging operation in a process from locking the switch trigger to releasing the switch trigger. The lubricating component delivers oil to the cutting element.

### CROSS REFERENCE TO RELATED APPLICATION

This application claims the benefit of and takes priority from Chinese Patent Application No. 202322017198.1 filed on Jul. 28, 2023, the contents of which are herein incorporated by reference.

### TECHNICAL FIELD

The present disclosure relates to a chain saw, in particular, to a chain saw with a lubricating structure.

### BACKGROUND

A chain saw is a portable power cutting tool mainly used in forest logging, garden pruning, furniture industry, and decoration industry. It is powered by a gasoline engine or a motor, and a sprocket is driven to drive a sawing chain to rotate around a guide plate to perform a cutting operation, achieving the purpose of performing cutting, pruning, and blanking on timber, branches, and materials. The cutting performance of a chain saw mostly depends on the saw chain, and the service life of the saw chain and the sharpness of a blade depend on a lubrication effect of the saw chain. If the saw chain running at a high speed and a guide plate maintain good lubrication, the cutting efficiency of the saw chain can be greatly improved and the service life of the saw chain can be greatly prolonged. If the lubrication of the saw chain running at a high speed and the guide plate is not ideal, the friction between the saw chain and a cut material and the guide plate will cause heating, wear, and even fracture. Therefore, in order to prevent the saw chain from being damaged and prolong the service life of the chain saw, oil needs to be continuously added during use of a chain of the chain saw.

A traditional chain saw adopts a manual oiling manner. During working of the chain, oil is pumped through a manual oil pump structure to lubricate it. A user presses an oil bubble with fingers, so as to generate a pressure inside an oil bottle to press out lubricating oil to lubricate the chain. However, in this way, the lubrication of the chain saw needs to be checked every once in a while, which is not beneficial to improving the production efficiency. Moreover, the pressure generated when manually pressing the oil bubble to deliver the oil is low; and the oil pump efficiency will be relatively low when a volume of the oil bottle is relatively large.

### SUMMARY

An objective of the present disclosure is to provide a chain saw convenient to lubricate.

In order to achieve the above objective of the present disclosure, the present disclosure provides a chain saw, which includes:
a case;
a working component extending out of the case, the working component having a cutting element and a guide plate supporting the cutting element;
a power drive device, including a motor positioned in the case, the motor being used for driving the cutting element to move around the guide plate;
a switch trigger, arranged on the case and used for starting the motor; and
a lubricating component, at least partially arranged in the case and used for providing oil for the cutting element.

The chain saw includes a lock knob capable of locking and releasing the switch trigger; the lubricating component includes an oil bubble that is arranged in the case and is close to the lock knob; the lock knob compresses the oil bubble to perform an oil discharging operation in a process from locking the switch trigger to releasing the switch trigger; and the lubricating component delivers oil to the cutting element.

As further improvement of an implementation of the present disclosure, the lock knob is capable of moving between a first position and a second position relative to the case; when the lock knob moves to the first position, the oil bubble is compressed by the lock knob to perform the oil discharging operation; when the lock knob moves to the second position, the oil bubble is compressed by the lock knob to perform the oil discharging operation; and when the lock knob moves to a middle position between the first position and the second position, the lock knob locks the switch trigger.

As further improvement of an implementation of the present disclosure, a trigger lever is connected between the lock knob and the oil bubble; the lock knob moves in a first direction in a process of locking and releasing the switch trigger; the trigger lever extends in a second direction at an angle to the first direction; and the lock knob moves in the first direction to drive the trigger lever to move in the second direction to compress the oil bubble.

As further improvement of an implementation of the present disclosure, a roller is connected below the lock knob; a guide surface is formed on an upper part of the trigger lever; the lock knob moves in the first direction to drive the roller to rotate along the guide surface; and the trigger lever compresses the oil bubble downward under an interaction between the roller and the guide surface.

As further improvement of an implementation of the present disclosure, a concave cam surface is formed on one end, matched with the lock knob of the trigger lever; a convex column is arranged below the lock knob; and the convex column moves along the cam surface to drive the trigger lever to move in the second direction.

As further improvement of an implementation of the present disclosure, the cam surface is symmetrically arranged in the first direction.

As further improvement of an implementation of the present disclosure, the convex column is constructed as a roller; and the roller rolls along the cam surface under the driving of movement of the lock knob in the first direction.

As further improvement of an implementation of the present disclosure, a front stop block and a rear stop block arranged at an interval extend from a lower part of the lock knob; in a position where the switch trigger is locked, the switch trigger is pressed against the front stop block, the roller is pivoted between the first stop block and the rear stop block; and the cam surface is clamped between the first stop block and the rear stop block.

As further improvement of an implementation of the present disclosure, the case includes a handle used for holding; in a longitudinal direction of the handle, the switch trigger and the oil bubble are staggered in the longitudinal direction and a direction perpendicular to the longitudinal direction; a switch element is arranged in the case; an extension arm extends from an upper part of the switch trigger; and the switch trigger pivots relative to the case to drive the extension arm to trigger the switch element.

As further improvement of an implementation of the present disclosure, the extension arm includes a vertical part and an inclined part; the switch trigger is arranged below a radial direction of the motor; the switch element is arranged in the radial direction of the motor and is staggered from a position of the switch trigger in a circumferential direction of the motor; a bottom of the switch trigger moves towards the interior of the handle to drive the extension arm to move outward to trigger the switch element; and an inclination direction of the inclined part is perpendicular to a triggering direction of the switch element.

Compared with the related art, the present disclosure has the beneficial effects that: according to the chain saw of the present disclosure, the lock knob is arranged to compress the oil bubble to perform the oil discharging operation in the process from locking the switch trigger to releasing the switch trigger. The switch trigger needs to be unlocked before operating the switch trigger to start the chain saw. The oil discharging operation can be completed in a process of unlocking and releasing the switch trigger. The oil bubble does not need to be additionally operated to discharge oil by an operator, so the chain saw is convenient to use.

### BRIEF DESCRIPTION OF THE DRAWINGS

FIG. 1 is a schematic structural diagram of a chain saw in a specific implementation of the present disclosure.

FIG. 2 is a sectional view of the chain saw in FIG. 1 along an A-A line.

FIG. 3 is a three-dimensional schematic diagram of part structures inside the chain saw in FIG. 1.

FIG. 4 is a rear view of the chain saw in FIG. 3.

FIG. 5 is a schematic diagram of the chain saw in FIG. 1 when a lock knob unlocks a switch trigger and the switch trigger is pressed to start a motor.

FIG. 6 is a sectional view of the chain saw in FIG. 5 along an A-A line.

### DETAILED DESCRIPTION OF THE EMBODIMENTS

The present disclosure is described below in detail in combination with various implementations shown in drawings. However, it is to be noted that these implementations do not limit the present disclosure. All equivalent transformations or substitutions on functions, methods, or structures made by those of ordinary skill in the art according to these implementations belong to the scope of protection of the present disclosure.

The terms used herein, such as “upper”, “above”, “lower”, and “below”, to represent relative space positions are for the purpose of description to describe the relationship of one unit or feature relative to another unit or feature as shown in the drawings. Terms of relative space positions can be intended to include different orientations except for the orientations shown in the diagram of equipment during using or working. For example, if the equipment in the drawings is overturned, then the units described as located “below” or “under” other units or features will be located “above” other units or features. Therefore, an exemplary term “below” may include two orientations, namely above and below. The equipment may be oriented in other manners (rotated by 90 degrees or other orientations), and descriptive words that are used herein and related to space are explained correspondingly.

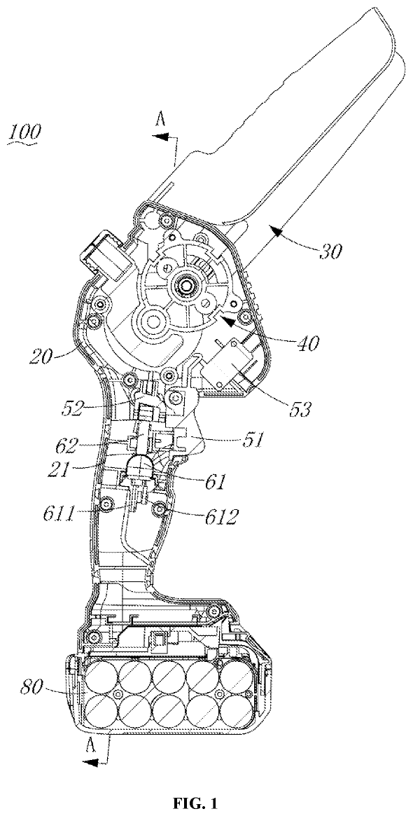

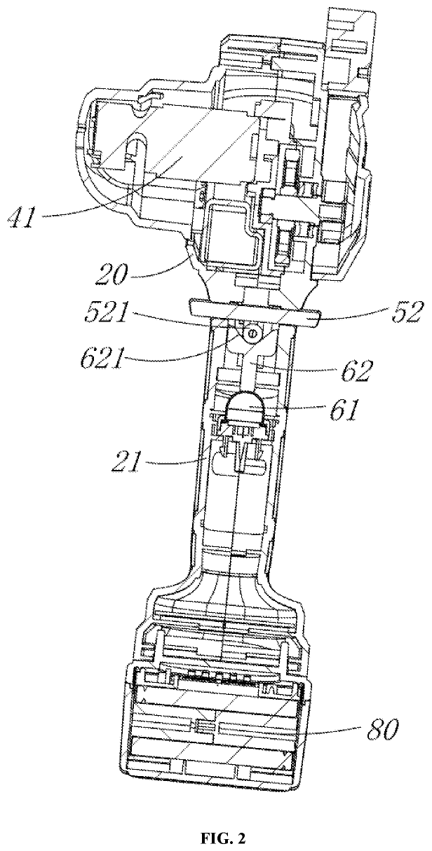

As shown in FIG. 1 and FIG. 2, the present disclosure discloses a chain saw 100. The chain saw 100 includes a case 20 and a working component 30 extending out of the case 20. The working component 30 has a cutting element and a guide plate supporting the cutting element. The cutting element moves around the guide plate to realize cutting of a workpiece. The chain saw 100 further includes a power drive device 40. The power drive device 40 includes a motor 41 positioned in the case. The motor 41 is used for driving the cutting element to move around the guide plate. The power drive device 40 may further include a transmission mechanism arranged between the motor 41 and the cutting element, so that the cutting element moves more stably and reliably. A switch trigger 51 is arranged on the case 20, and the switch trigger 51 is used for starting the motor 41.

Further, the chain saw 100 further includes a lubricating component, which is at least partially arranged in the case 20 and is used for providing oil for the cutting element. The lubricating component includes an oil tank and an oil bubble 61. The oil bubble 61 is connected to an oil inlet pipe 611 and an oil outlet pipe 612. The oil inlet pipe 611 of the oil bubble 61 is connected to the oil tank. The oil outlet pipe 612 of the oil bubble 61 leads to the cutting element. Lubricating oil in the oil tank can be output to the cutting element through the oil outlet pipe 612 of the oil bubble 61 by compressing the oil bubble 61.

Preferably, the chain saw 100 includes a lock knob 52 capable of locking and releasing the switch trigger 51. The oil bubble 61 that is arranged in the case 20 and is close to the lock knob 52. The lock knob 52 compresses the oil bubble 61 to perform an oil discharging operation in a process from locking the switch trigger 51 to releasing the switch trigger 51. The lubricating component delivers oil to the cutting element. Thus, the switch trigger 51 needs to be unlocked before operating the switch trigger 51 to start the chain saw. The oil discharging operation can be completed in a process of unlocking and releasing the switch trigger 51. The oil bubble 61 does not need to be additionally operated to discharge oil by an operator, so the chain saw is convenient to use.

Further, the lock knob 52 is capable of moving between a first position and a second position relative to the case 20; when the lock knob 52 moves to the first position, the oil bubble 61 is compressed by the lock knob 52 to perform the oil discharging operation; when the lock knob 52 moves to the second position, the oil bubble 61 is compressed by the lock knob 52 to perform the oil discharging operation; and when the lock knob 52 moves to a middle position between the first position and the second position, the lock knob 52 locks the switch trigger 51. That is, when the power drive device 40 does not work, that is, the switch trigger 51 is in an untriggered state, and the switch trigger 51 is locked through the lock knob 52 to prevent the switch trigger 51 from being triggered by mistake. Movement of the lock knob 52 for unlocking the switch trigger 51 links the oil discharging operation of the oil bubble 61 to realize an effect of discharging oil automatically, which is convenient to operate, and effectively solves problems that an operator forgot to add the lubricating oil or adds too much lubricating oil at once. Moreover, an oil discharging action links the knob 52, and there is a short time interval between the oil discharging operation and the triggering of the switch trigger 51, so that the lubricating oil may be delivered and attached to the cutting element more reliably. No matter the lock knob 52 is in the first position or the second position, the oil bubble 61 can be compressed to perform the oil discharging operation, which ensures that the lubricating oil can be added before starting, and the use of the chain saw is more reliable.

A left side and a right side of the lock knob 52 penetrate through the case 20, so that the switch trigger 51 can be unlocked by sliding the lock knob 52 leftwards or rightwards in the case 20. The lock knob 52 moves in a first direction in a process of locking and releasing the switch trigger 51, and a left-right sliding direction of the lock knob 52 may be considered as the first direction. A trigger lever 62 is connected between the lock knob 52 and the oil bubble 61. The trigger lever 62 extends in a second direction at an angle to the first direction. The lock knob 52 moves in the first direction to drive the trigger lever 62 to move in the second direction to compress the oil bubble 61. Preferably, the second direction is an approximate vertical direction, space in the case 20 below the lock knob 52 can be effectively used, the mounting of the oil bubble 61 and the trigger lever 62 in the case 20 is reliable, and the compression of the trigger lever 62 to the oil bubble 61 is stable and reliable.

Further, a roller 521 is connected below the lock knob 52; a guide surface 621 is formed on an upper part of the trigger lever 62; the lock knob 52 moves in the first direction to drive the roller 521 to rotate along the guide surface; and the trigger lever 62 compresses the oil bubble 61 downward under an interaction between the roller 521 and the guide surface 621. The guide surface 621 may be a cam surface, an inclined surface, an arc surface, or the like. The roller 521 rotates along the guide surface 621 to drive the trigger lever 62 to move up and down, which reduces the force for sliding the lock knob 52 left and right, so that the action of unlocking the switch trigger 51 by the operator can be labor-saving and convenient to operate.

Of course, the trigger lever 62 may also be driven in a manner of sliding between the lock knob 52 and the trigger lever 62. A concave cam surface is formed on one end, matched with the lock knob 52 of the trigger lever 62. A convex column is arranged below the lock knob 52; and the convex column moves along the cam surface to drive the trigger lever 62 to move in the second direction. The convex column can slide along the cam surface to drive the trigger lever to move up and down. The cam surface is arranged in bilateral symmetry in the first direction, so that the oil bubble 61 can be compressed no matter the lock knob 52 moves leftwards or rightwards.

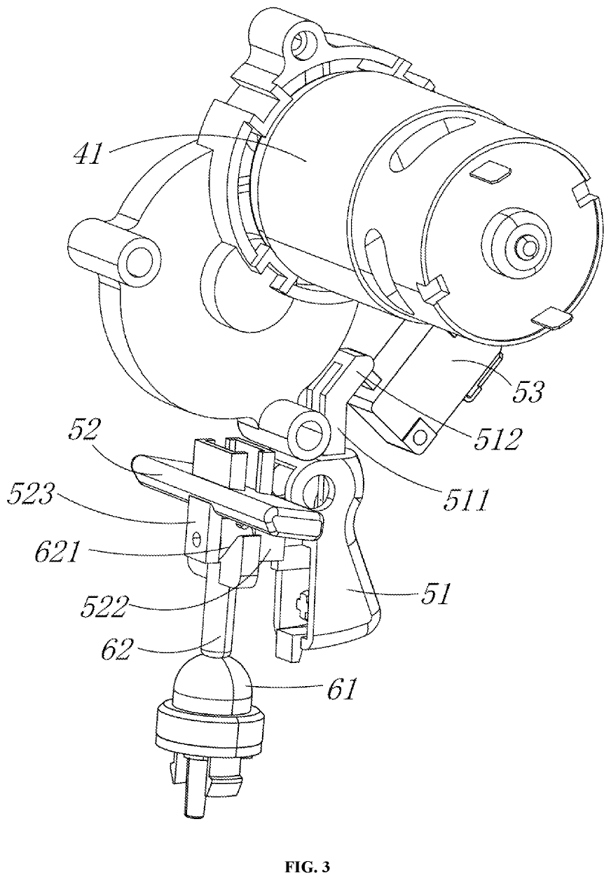

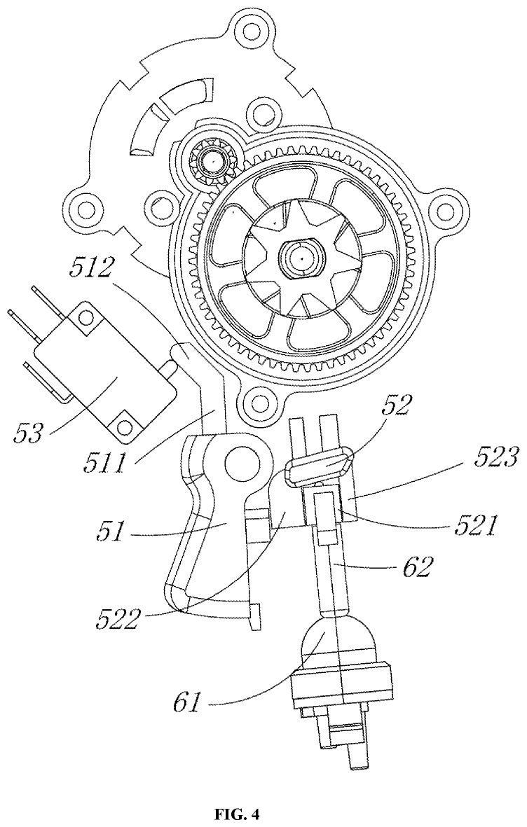

Referring to FIG. 3 and FIG. 4, the convex column may be a convex part fixed below the lock knob 52. In this embodiment, the convex column is constructed as a roller 521. The roller 521 rolls along the cam surface under the driving of the lock knob 52 in the first direction. Sliding is changed into rolling, so that the movement between the lock knob 52 and the trigger lever 62 is more smooth. A front stop block 522 and a rear stop block 523 arranged at an interval extend from a lower part of the lock knob 52; in a position where the switch trigger 51 is locked, the switch trigger 51 is pressed against the front stop block 522, the roller 521 is pivoted between the first stop block 522 and the rear stop block 523; and the cam surface is also clamped between the first stop block 522 and the rear stop block 523. Two stop blocks are arranged, which not only realizes locking and limiting of the switch trigger 51, but also realizes the supporting for the roller 521, and the stop blocks can also form a limit to the trigger lever 62, so that the overall structure is more reliable.

The case 20 includes a handle 21 used for holding, and the handle 21 is a holding position of the operator. In a longitudinal direction of the handle 21, the switch trigger 51 and the oil bubble 61 are staggered in the longitudinal direction and a direction perpendicular to the longitudinal direction; a switch element 53 is arranged in the case 20; an extension arm extends from an upper part of the switch trigger 51; and the switch trigger 51 pivots relative to the case 20 to drive the extension arm to trigger the switch element 53. The arm extends from the upper part of the switch trigger 51 triggers the switch element 53. The switch element 53 may be arranged at an upper inclined position of the switch trigger 51 without occupying the space inside the handle 21, which facilitates the mounting of an oil bubble component inside the handle 21.

Specifically, the extension arm includes a vertical part 511 and an inclined part 512. The switch trigger 51 is arranged below a radial direction of the motor 41; the switch element 53 is arranged in the radial direction of the motor 41 and is staggered from a position of the switch trigger 51 in a circumferential direction of the motor 41; a bottom of the switch trigger 51 moves towards the interior of the handle 21 to drive the extension arm to move outward to trigger the switch element 53; and an inclination direction of the inclined part 512 is perpendicular to a triggering direction of the switch element 53. The inclined part 512 is arranged on the extension arm, so that a force can be applied to the switch trigger 51 more conveniently, and the arrangement of the switch trigger 51 and the switch element 53 is more compact.

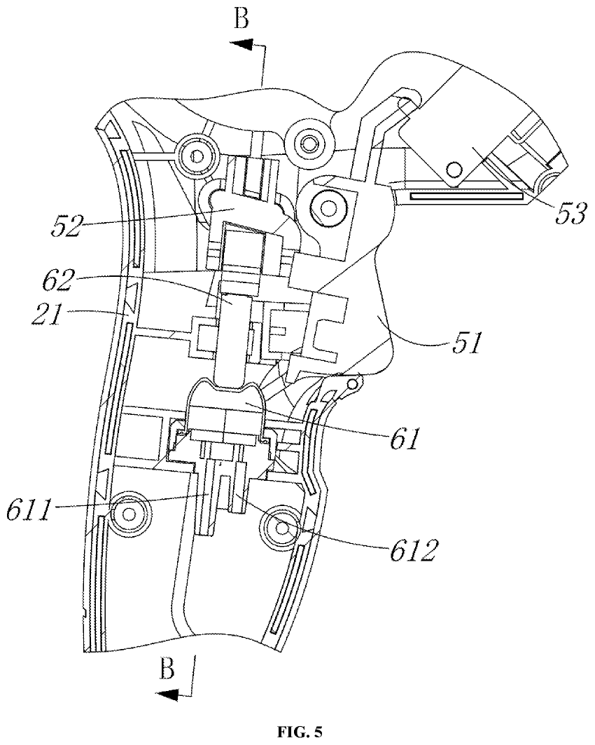

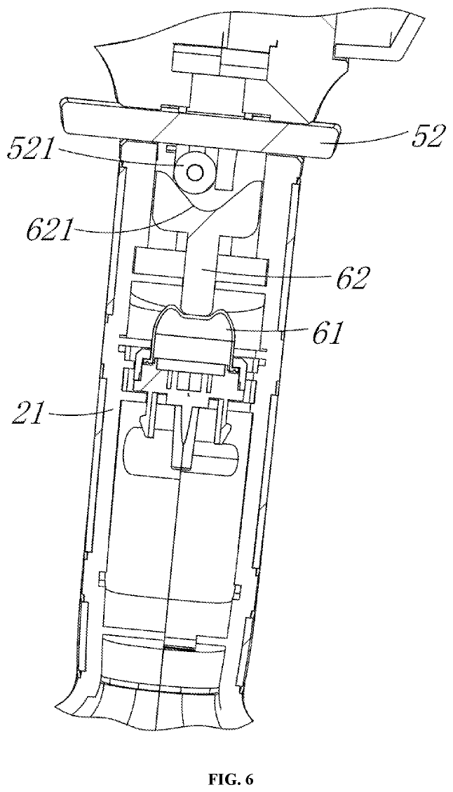

Referring to FIG. 5 and FIG. 6, before an operator operates the chain saw 100 to work, the lock knob 52 is moved left or right to select a rotation direction of the motor 41 and unlock the switch trigger 51 simultaneously. The lock knob 52 drives the trigger lever 62 to move to compress the oil bubble 61 downwards, and the lubricating component delivers the oil to the cutting element. Then, the switch trigger 51 is pressed into the handle 21, the front stop block 522 of the lock knob 52 is staggered relative to the switch trigger 51, and the switch trigger 51 can be smoothly pressed to start the motor 41. The switch trigger 51 is connected to an elastic element. The elastic element applies an elastic force to the switch trigger 51, so that when the switch trigger 51 deviates from an initial position, it has a tendency to return to the initial position. The elastic element may be a compression spring or a torsional spring. In addition, the trigger lever 62 may also be connected to the elastic element. The elastic element may also enable the trigger lever 62 to have the tendency to return to the initial position when deviating from the initial position. After the switch trigger 51 returns to the initial position, the lock knob 52 moves back to lock the switch trigger 51 again.

A bottom of the case 20 is used for mounting a battery pack 80, so that the chain saw does not need to connect an external power supply, a use occasion of the chain saw is not limited, and the use is more convenient.

According to the chain saw in the above implementations, other structures or functions of this connection are not improved, so other structures of the chain saw is not described in detail here.

For those skilled in the art, it is obvious that the present disclosure is not limited to the details of the above exemplary embodiments, and can be implemented in other specific forms without departing from the spirit or basic features of the present disclosure. Therefore, from any point of view, the embodiments should be regarded as exemplary but not restrictive. The scope of the present disclosure is limited by the attached claims rather than the above description. Therefore, it is intended to include all changes within the meaning and scope of the equivalent elements of the claims in the present disclosure. Any reference sign in the claims shall not be regarded as limiting the claims involved.

In addition, it should be understood that although the specification is described according to implementations, not every implementation only contains an independent technical solution. This description of the specification is only for the sake of clarity. Those skilled in the art should take the specification as a whole, and the technical solutions in the various embodiments can also be properly combined to form other implementations that can be understood by those skilled in the art.

What is claimed is:

1. A chain saw, comprising:
a case;
a working component extending out of the case, the working component having a cutting element and a guide plate supporting the cutting element;
a power drive device, comprising a motor positioned in the case, the motor being used for driving the cutting element to move around the guide plate;
a switch trigger, arranged on the case and used for starting the motor; and
a lubricating component, at least partially arranged in the case and used for providing oil for the cutting element, wherein
the chain saw comprises a lock knob capable of locking and releasing the switch trigger; the lubricating component comprises an oil bubble that is arranged in the case and is close to the lock knob; the lock knob compresses the oil bubble to perform an oil discharging operation in a process from locking the switch trigger to releasing the switch trigger; and the lubricating component delivers oil to the cutting element.

2. The chain saw according to claim 1, wherein the lock knob is capable of moving between a first position and a second position relative to the case; in a case that the lock knob moves to the first position, the oil bubble is compressed by the lock knob to perform the oil discharging operation; in a case that the lock knob moves to the second position, the oil bubble is compressed by the lock knob to perform the oil discharging operation; and in a case that the lock knob moves to a middle position between the first position and the second position, the lock knob locks the switch trigger.

3. The chain saw according to claim 1, wherein a trigger lever is connected between the lock knob and the oil bubble; the lock knob moves in a first direction in a process of locking and releasing the switch trigger; the trigger lever extends in a second direction at an angle to the first direction; and the lock knob moves in the first direction to drive the trigger lever to move in the second direction to compress the oil bubble.

4. The chain saw according to claim 3, wherein a roller is connected below the lock knob; a guide surface is formed on an upper part of the trigger lever; the lock knob moves in the first direction to drive the roller to rotate along the guide surface; and the trigger lever compresses the oil bubble downward under an interaction between the roller and the guide surface.

5. The chain saw according to claim 3, wherein a concave cam surface is formed on one end, matched with the lock knob of the trigger lever; a convex column is arranged below the lock knob; and the convex column moves along the cam surface to drive the trigger lever to move in the second direction.

6. The chain saw according to claim 5, wherein the cam surface is symmetrically arranged in the first direction.

7. The chain saw according to claim 5, wherein the convex column is constructed as a roller; and the roller rolls along the cam surface under the driving of movement of the lock knob in the first direction.

8. The chain saw according to claim 7, wherein a front stop block and a rear stop block arranged at an interval extend from a lower part of the lock knob; in a position where the switch trigger is locked, the switch trigger is pressed against the front stop block, the roller is pivoted between the first stop block and the rear stop block; and the cam surface is clamped between the first stop block and the rear stop block.

9. The chain saw according to claim 1, wherein the case comprises a handle used for holding; in a longitudinal direction of the handle, the switch trigger and the oil bubble are staggered in the longitudinal direction and a direction perpendicular to the longitudinal direction; a switch element is arranged in the case; an extension arm extends from an upper part of the switch trigger; and the switch trigger pivots relative to the case to drive the extension arm to trigger the switch element.

10. The chain saw according to claim 9, wherein the extension arm comprises a vertical part and an inclined part; the switch trigger is arranged below a radial direction of the motor; the switch element is arranged in the radial direction of the motor and is staggered from a position of the switch trigger in a circumferential direction of the motor; a bottom of the switch trigger moves towards the interior of the handle to drive the extension arm to move outward to trigger the switch element; and an inclination direction of the inclined part is perpendicular to a triggering direction of the switch element.
